(19) United States
(12) Patent Application Publication
(10) Pub. No.: US 2003/0206182 A1
(43) Pub. Date: Nov. 6, 2003

(54) Synchronized graphical information and time-lapse photography for weather presentations and the like

(75) Inventors: Terence F. Kelly, Madison, WI (US); John S. Moore, Middleton, WI (US); David N. Erickson, Madison, WI (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(73) Assignee: WEATHER CENTRAL, INC. WISCONSIN CORPORATION, MADISON, WI (US)

(21) Appl. No.: 09/909,553

(22) Filed: Jul. 20, 2001

(51) Int. Cl. G09G 5/00

(52) U.S. Cl. 345/632

(57) ABSTRACT

A dynamic graphical information presentation is generated and overlaid onto a time-lapse video image sequence to form a combined graphical information and time-lapse photography presentation. The time-lapse photography video image sequence and dynamic graphical information presentation are preferably time synchronized in the combined presentation. For a weather presentation of past weather conditions, the time-lapse photography video image sequence may be a video image sequence of sky conditions, with the dynamic graphical information presentation generated based on weather conditions recorded for the same period of time from a weather information source. For a presentation of forecast weather conditions, the time-lapse photography video image sequence may be selected from a database of stored prerecorded sequences, with the dynamic graphical information presentation derived from forecast weather condition information.

### FIELD OF THE INVENTION

The present invention pertains generally to time-lapse photography and to presentations including time-lapse photography, and to systems and methods for preparing weather presentations including computer generated graphical information regarding past, present, and forecast weather conditions in combination with time-lapse photography of sky conditions.

### BACKGROUND OF THE INVENTION

Modern televised weather reports incorporate computer generated graphical information in combination with video clips and live presenters to provide weather reports which are both informative and entertaining. Such reports are typically prepared by a meteorologist or other technician based upon weather information provided from a variety of weather information sources, including forecast data from weather forecasting models. Computer based production equipment is employed for generating graphical displays of weather information and for combining the graphical displays with video clips to provide the entire weather report presentation.

Weather information sources which may be employed by the meteorologist to generate a weather presentation include local and remote weather stations, weather radar, and satellite information, along with visual observations. Remote or local automated or manned weather stations provide information to the meteorologist on current and past weather conditions such as temperature, precipitation, wind speed and direction, etc. Weather radar information, which may include highly detailed NEXRAD weather radar information provided by the government or less detailed, but more current, local live weather radar information, provides the meteorologist with information on the past and current movement of storm fronts and other weather phenomena. Satellite imagery provides similar information to the meteorologist. Weather station, radar, and satellite information may be employed by the meteorologist to generate an integrated graphical weather presentation in which past and current weather information is presented to a viewer in an easily understandable form. Such weather information, from a variety of sources, in combination with weather forecast model data, may be employed to generate an easily understandable weather forecast report for viewers.

Computer-based systems, including detailed computerized geographic maps, and other graphics generating capabilities, may be employed to combine the information provided from various weather information sources and forecast models into an integrated weather report. Computer-generated graphics are often combined with live presenters and live or recorded video clips to provide a complete weather presentation to a viewer as part of a televised weather presentation. For example, such a presentation may include live video of current weather conditions, or recorded video clips of weather conditions occurring during the day for which the weather report is provided.

Video clips of past and current weather conditions employed as part of a televised weather presentation may include time-lapse photography video presentations. For example, a video camera may be positioned to take a video image of the sky conditions evolving throughout a day or other time period of interest (e.g., taken near a landmark which will be recognizable by viewers of the weather presentation). The video camera may be computer controlled to take frames of video images at spaced apart time intervals throughout the time period of interest. When the time-lapse video created in this manner is played back at normal speed, a sped-up video image of evolving sky conditions is presented. Using time-lapse photography in this manner, a televised weather report may present a dramatic video summary of evolving sky conditions throughout an entire day with a video clip running only a few seconds.

A video camera may be controlled so as to record a time-lapse video presentation of sky conditions which, when played back as part of a televised weather presentation, accelerates gradually from normal speed at the beginning of the presentation and decelerates gradually to normal speed at the end of the presentation. This provides a smooth and easily viewable time-lapse video presentation, without unnaturally abrupt starts and stops. Such a time-lapse photography video presentation may be achieved by recording video frames more frequently near the beginning and end of the presentation, while gradually increasing the time between the recording of video frames as the time from the two ends of the video presentation increases, such that a sped-up time-lapse video presentation is provided during the middle of the presentation, with video recorded at more normal speed at the beginning and end thereof.

In a typical televised weather presentation, a summary of the past days' weather conditions is presented in a substantially static computer-generated graphical display. For example, such a display may show the high and low temperatures for the day, when those temperatures were reached, a general summary of wind speed and direction for the day, and, perhaps, a graphical representation of general sky conditions, e.g., sunny, cloudy, rain, etc. A dynamic time-lapse video display of evolving sky conditions through the day is typically presented separately from such a static graphical display of weather conditions.

What is desired is a system and method for combining time-lapse photography video images of evolving sky conditions with a dynamic time synchronized graphical presentation of corresponding weather conditions throughout the period represented by the time-lapse video to form a combined synchronized graphical information and time-lapse photography weather presentation. Such a system and method may employ a recorded time-lapse photography video image sequence in combination with a synchronized graphical presentation of corresponding recorded weather condition information, to provide a dynamic presentation of past weather conditions. Such a system may also employ recorded time-lapse photography video image sequences in combination with dynamic graphical information derived from weather forecast information, to provide a dynamic presentation of forecast weather conditions.

### SUMMARY OF THE INVENTION

The present invention provides a system and method for combining a time-lapse photography video image sequence with time synchronized graphical information. For example, the present invention may be employed to produce a dynamic weather presentation including integrated time-lapse video of evolving sky conditions in combination with a time synchronized dynamic graphical presentation of weather condition information, such as temperature, precipitation, wind conditions, etc. In accordance with the present invention, a time-lapse photography video image sequence of sky conditions may be recorded simultaneously with weather condition information, in a time synchronized manner, to facilitate generation of a dynamic time synchronized graphical information and time-lapse photography presentation of past weather conditions. Alternatively, prerecorded video image sequences may be combined with a dynamic graphical weather condition presentation derived from forecast weather information to generate a dynamic combined graphical information and time-lapse photography weather presentation of forecast weather conditions. The time-lapse photography images used for generating such a forecast presentation may be selected from a database of video images to correspond with the forecast weather conditions reflected in the graphical weather information included in the dynamic weather forecast presentation.

A production system for generating a combined graphical information and time-lapse photography weather presentation in accordance with the present invention may be implemented using one or more conventional computer processors. Weather information is provided to the system from a variety of weather information sources, including weather stations, weather radar, and/or weather satellite information sources. Local or remote weather stations may provide weather information such as current temperature, accumulated precipitation, wind speed and direction, etc., to the system. Preferably, automatic unmanned commercially available weather station equipment may be used to provide such weather information to the system. The system may also include a weather forecast modeling capability, to generate forecast weather condition information, or may be adapted to receive such forecast weather condition information from a separate weather forecast modeling system. The production system may be programmed so as to generate a dynamic graphical weather information presentation from the recorded past weather condition information or from the predicted forecast weather condition information. The system is also adapted to receive time-lapse photography video image sequences, e.g., of sky conditions. Such time-lapse photography video image sequences may be provided by a video camera, which may be under control of the system. Alternatively, time-lapse photography video image sequences may be retrieved by the system from a database of stored video image sequences. In accordance with the present invention, the system is programmed to combine the dynamic graphical information presentation generated by the system from recorded past or forecast weather condition information with a selected time-lapse photography video image sequence, under operator control, to produce a combined dynamic graphical information and time-lapse photography video presentation in accordance with the present invention. Such a combined graphical information and time-lapse photography presentation may be provided from the production system to a broadcast system, for example, to be televised as part of a televised weather presentation.

A combined graphical information and time-lapse photography presentation in accordance with the present invention may include as a background layer a time-lapse photography video image sequence, with a dynamic graphical information presentation superimposed or overlaid on a portion of the time-lapse photography video image sequence background. For example, for a combined graphical information and time-lapse photography weather presentation in accordance with the present invention, the background time-lapse photography video image sequence may be a time-lapse photography video image sequence of sky conditions over a selected time period. In such a case, the dynamic graphical information presentation overlaid on the time-lapse photography video image sequence of sky conditions may include dynamic graphical representations of various weather conditions over the same selected time period. For example, the dynamic graphical weather information presentation may include a dynamic graphical display of temperature, cumulative precipitation, wind speed, wind direction, etc. Preferably, the time-lapse photography video image sequence and dynamic graphical information presentation forming the combined graphical information and time-lapse photography presentation are time synchronized, such that, for example, the weather condition information indicated at any point in time by the dynamic graphical information presentation corresponds to the weather conditions at the same point in time presented in the time-lapse photography video image sequence background of the combined presentation. Preferably, the combined graphical information and time-lapse photography presentation may also include a time-lapse clock display, overlaid on the time-lapse photography video image sequence along with or as part of the dynamic graphical information presentation, so that a viewer of the presentation knows the time of day which is being presented at any one point in time by the combined graphical information and time-lapse photography presentation.

Combined graphical information and time-lapse photography presentations in accordance with the present invention may include combined graphical information and time-lapse photography weather presentations of past weather conditions, as well as combined graphical information and time-lapse photography presentations of forecast weather conditions. For a combined graphical information and time-lapse photography presentation of past weather conditions, a time-lapse video image sequence of sky conditions is recorded for a selected period of time (e.g., a day). Weather conditions are recorded for the same time period. The recorded time-lapse photography video image sequence and corresponding weather condition information are preferably scaled for the same timeframe, such that when the recorded weather condition information is combined with the recorded time-lapse photography video image sequence, the weather condition information, presented as a dynamic graphical information presentation overlaid on the time-lapse photography video image sequence, is timeframe synchronized with the time-lapse photography video image sequence. This may be achieved, for example, by recording current weather condition information each time a frame, or a selected subset of frames, of the image forming the time-lapse photography video image sequence is recorded. Alternatively, such scaling may be performed after the fact, employing time stamping of the video image sequence and recorded weather condition information at the time each is recorded. A dynamic graphical weather information presentation is generated from the scaled (time synchronized) weather condition information. The dynamic graphical information presentation is combined with (e.g., overlaid on) the time-lapse photography video image sequence to form a time synchronized combined graphical information and time-lapse photography presentation. The combined graphical information and time-lapse photography presentation of past weather conditions may then be displayed, e.g., broadcast, for example, as part of a televised weather report presentation, or saved or distributed in any other conventional manner.

A combined graphical information and time-lapse photography weather presentation of forecast weather conditions may also be generated in accordance with the present invention. For generating such a presentation of forecast weather conditions, the forecast weather conditions to be included as part of the presentation must be defined for a particular time period to be covered by the presentation. Such forecast weather conditions may be defined manually or automatically based on weather forecast information, such as, for example, weather forecast modeling information. The forecast weather conditions thus defined are then examined, and a searchable database of video image sequences of sky conditions is searched for prerecorded video image sequences which show weather phenomena corresponding to the forecast weather conditions. The video image sequences selected in this manner may then be scaled to the desired timeframe for the combined graphical information and time-lapse photography forecast weather presentation to be produced. A corresponding dynamic graphical information presentation of the defined forecast weather conditions is generated for the same timeframe. The selected scaled video image sequence and dynamic graphical information presentation are then combined, such as by overlaying the dynamic graphical information presentation onto the video image sequences in a synchronized manner, to generate a combined graphical information and time-lapse photography weather forecast presentation in accordance with the present invention. The combined graphical information and time-lapse photography weather forecast presentation may then be displayed, e.g., by broadcasting the presentation as part of a televised weather report presentation, or saved or distributed in any other conventional manner.

Further objects, features, and advantages of the invention will be apparent from the following detailed description taken in conjunction with the accompanying drawings.

### BRIEF DESCRIPTION OF THE DRAWINGS

In the drawings:

FIG. 1 is a schematic block diagram of an exemplary system for generating a combined graphical information and time-lapse photography presentation in accordance with the present invention.

FIG. 2 is an exemplary single frame of a combined graphical information and time-lapse photography weather presentation which may be generated in accordance with the present invention.

FIG. 3 is a simplified exemplary flowchart diagram of a method for generating a combined graphical information and time-lapse photography weather presentation of past weather conditions in accordance with the present invention.

FIG. 4 is a simplified exemplary flowchart diagram of a method for generating a combined graphical information and time-lapse photography weather presentation of forecast weather conditions in accordance with the present invention.

### DETAILED DESCRIPTION OF THE INVENTION

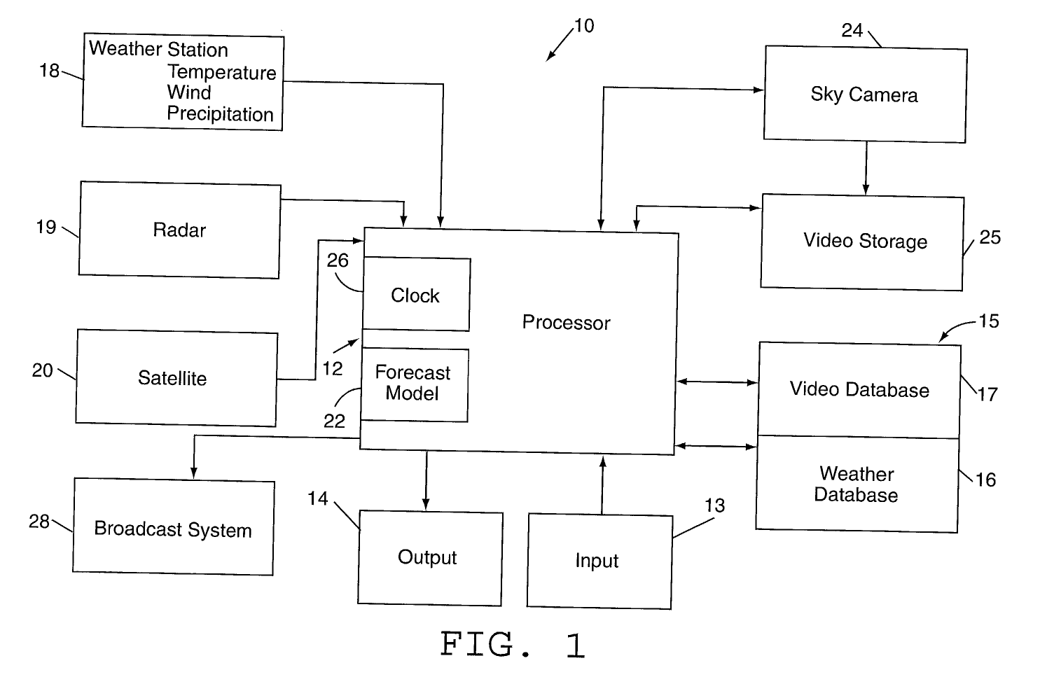

An exemplary production system 10 which may be used for generating a combined graphical information and time-lapse photography presentation in accordance with the present invention is illustrated in the schematic block diagram of FIG. 1, and will be described in detail with reference thereto. Although the present invention will be described in detail herein with reference to the exemplary application thereof to generating a combined graphical information and time-lapse photography weather presentation, it should be understood that a system and method in accordance with the present invention may be employed to generate combined graphical information and time-lapse photography presentations for other similar or different subject matter.

A production system 10 for generating a combined graphical information and time-lapse photography presentation in accordance with the present invention may preferably be implemented substantially in software procedures running on one or more conventional system computer processors 12. The system processor 12 may have associated therewith conventional input devices 13, e.g., a keyboard, mouse, etc., for providing operator input to the processor 12 to control the operation of the system 10. One or more conventional output devices 14, such as monitors, printers, etc., may also be associated with the system processor 12. Conventional memory 15 associated with the system processor 12 is used to store the programming instructions which control operation of the processor 12, such as the programming instructions for implementing a method for generating a combined graphical information and time-lapse photography presentation in accordance with the present invention. Memory 15 may also be employed to store a database 16 of recorded actual or predicted forecast weather condition information and/or a database 17 of video image sequences, as will be discussed in more detail below.

Weather information may be provided to the system 10 from a variety of weather information sources. Such sources may include, for example, weather stations 18, weather radar 19, and weather satellite imagery 20 sources. Weather station 18 sources of weather information provide current weather condition information for a particular local or remote location of interest to the system 10. Such weather information may include, for example, current temperature, wind speed and direction, and accumulated precipitation weather information, etc. Such information may be provided from the weather station to the system 10 manually, such as by manual visual observation of various weather station instruments with subsequent manual inputting of weather condition information into the system 10, or automatically. A conventional automatic weather station may be employed to provide weather information automatically to the system 10. Weather radar information sources 19 may include highly detailed NEXRAD weather radar information provided by the government, and/or information from local weather radar, which may be updated more rapidly, but which includes less detailed weather information, than NEXRAD. Satellite weather information sources 20 may provide weather condition imagery to the system 10. Data transfer formats for receiving weather information from weather stations 18, weather radar sources 19, and weather satellite sources 20, by the system 10 may be obtained from the manufacturers of automatic weather stations 18 and weather radars 19, and/or from the providers of radar 19 and weather satellite 20 weather information. Weather information received by the system 10 from the various weather information sources 18, 19, and 20, may be stored by the system processor 12 for use in accordance with the present invention in the weather database 16 portion of memory 15 associated with the system processor 12.

The weather information sources 18, 19, and 20 provide information on past and current weather conditions to the system 10. The system processor 12 may also implement a weather forecasting model 22, for generating forecast weather condition information. Alternatively, weather forecast model information may be provided to the system 10 from an independent weather forecasting model system. An exemplary weather forecasting model which may be employed to generate detailed and high resolution weather forecast information is the commercially available ADONIS Microcast weather forecast modeling product available from Weather Central, Inc., of Madison, Wis. As will be described in more detail below, forecast weather information may also be provided to the system 10 manually, e.g., by a meteorologist employing the system processor input device 13 to enter forecast weather condition information to the system 10. Weather forecast information of any form may be stored in the weather database 16 portion of memory 15 for use in accordance with the present invention.

In accordance with the present invention, the system 10 may employ a conventional video camera 24 to obtain conventional video image sequences. For example, for a system 10 in accordance with the present invention for generating a combined graphical information and time-lapse photography weather presentation, the video camera 24 may be positioned to take video image sequences of sky conditions. The video camera 24 may preferably take digital video image sequences which may be stored in a digital video storage device 25 (e.g., memory). Alternatively, the video camera 24 may take analog video image sequences which may be stored in conventional analog video storage formats, e.g., video tape. In the latter case, the analog video images taken by the camera 24 and stored in video storage 25 are preferably, at some point, converted into a digital video format, in a conventional manner, to facilitate manipulation of the images by the system processor 12 for generating a combined graphical information and time-lapse photography presentation in accordance with the present invention.

Operation of the video camera 24 is preferably under control of the system processor 12. Thus, for example, the system processor 12 may control the rate at which individual spaced apart image frames are taken by the video camera 24, thereby to generated a time-lapse photography video image sequence.

The system processor 12 may also be provided with a database 17 of pre-recorded video image sequences, for use by the system 10. Such a database 17 of pre-recorded video image sequences of sky conditions may be used for generating a combined graphical information and time-lapse photography presentation of forecast weather conditions in accordance with the present invention, as will be described in more detail below.

The system processor 12 preferably incorporates a real time clock function 26, which may be implemented in a conventional manner. The real time clock function 26 may be employed by the processor 12 to time stamp weather information received from the weather information sources 18, 19, and 20 and stored in the weather database by the system processor 12. The real time clock function 26 may also be employed to time stamp video image sequences obtained by the system 10 via the video camera 24. Thus, the real time clock function 26 facilitates timeframe synchronization of recorded weather information with time-lapse photography video image sequences. The real time clock function 26 is also employed for the generation of a time-lapse clock display on a combined graphical information and time-lapse photography presentation in accordance with the present invention, as will be discussed in more detail below.

The production system 10 may preferably be coupled to a conventional television broadcast system 28. A combined graphical information and time-lapse photography weather presentation generated by the system 10 in accordance with the present invention may, therefore, be provided directly to a broadcast system 28 for broadcast, e.g., as part of a televised weather report presentation. Alternatively, a combined graphical information and time-lapse photography weather presentation generated by the system 10 in accordance with the present invention may be stored by the system 10, either internal or external thereto, in any known analog or digital format, and/or displayed or transmitted in any other conventional format over any conventional medium.

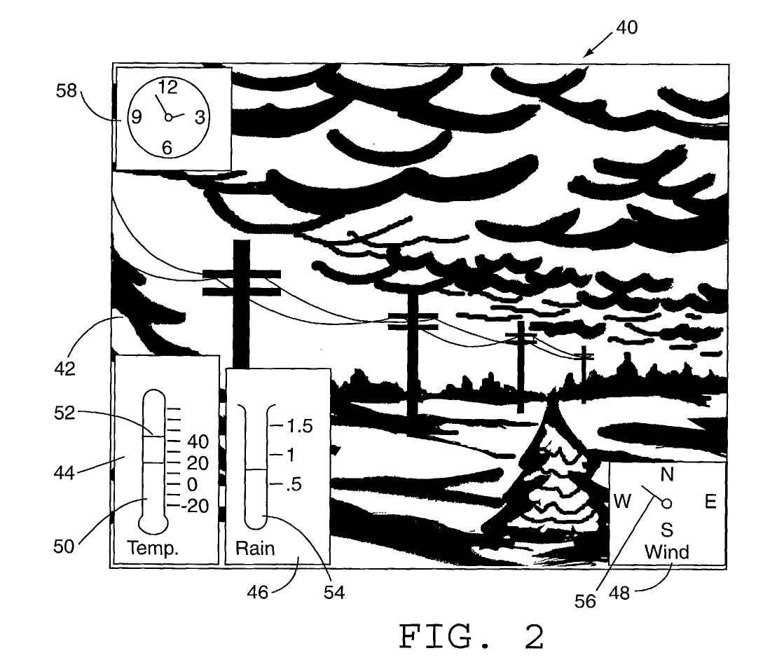

A single frame of an exemplary combined graphical information and time-lapse photography weather presentation 40 in accordance with the present invention is illustrated in, and will be described with reference to, FIG. 2. The exemplary combined graphical information and time-lapse photography presentation 40 includes a background layer 42 which is comprised of a time-lapse photography video image sequence, for example, of sky conditions at a location of interest. In accordance with the present invention, a dynamic graphical information presentation, e.g., a dynamic graphical information weather presentation, is overlaid onto the time-lapse photography video image sequence background 42 to form the combined graphical information and time-lapse photography presentation 40. For example, the dynamic graphical information presentation overlaid on the time-lapse photography video image sequence background 42 of the exemplary combined graphical information and time-lapse photography presentation 40 illustrated in FIG. 2 includes a dynamic graphical temperature 44, precipitation 46, and wind direction 48 presentation.

A dynamic graphical information temperature presentation 44 may, for example, take the form of a graphically represented thermometer. The graphically represented fluid 50 in the thermometer may be dynamically animated to rise and fall corresponding to changes in temperature throughout the time period represented by the combined graphical information and time-lapse photography presentation 40. The dynamic graphical information thermometer presentation 44 may include a mark 52 or other indication thereon which indicates, for example, the high and/or low temperatures reached during the time period represented in the combined graphical information and time-lapse photography presentation 40. Such an indicating mark 52 may preferably be added dynamically to the graphical thermometer presentation 44, e.g., at the point in time during the presentation when the temperature indicated by the thermometer presentation 44 reaches the high and/or low temperature mark to be indicated thereby. Of course, changing temperatures throughout a time period of interest may be indicated in a dynamic graphical information presentation format which is different from the thermometer presentation illustrated in FIG. 2. For example, a dynamic graphical representation of a conventional dial type thermometer may be included in the dynamic graphical information presentation.

As illustrated in FIG. 2, a dynamic graphical presentation of precipitation 46 may take the form of, for example, a graphically represented rain gauge or similar precipitation measuring device. For such a dynamic graphical information presentation, for example, the fluid level 54 in the graphically represented gauge may increase dynamically through the duration of the combined graphical information and time-lapse photography presentation 40, thereby to indicate dynamically accumulating precipitation throughout the period represented by the combined graphical information and time-lapse photography presentation 40.

As illustrated in FIG. 2, wind direction during the period represented by the combined graphical information and time-lapse photography presentation 40 may be indicated by a graphically represented compass 48. The direction pointed to by a graphically represented needle 56 on the compass 48 may be updated dynamically throughout the combined graphical information and time-lapse photography presentation 40 to indicate changing wind directions during the period represented by the presentation.

Of course, it should be understood, that not all of the weather condition information presented in the exemplary combined graphical information and time-lapse photography presentation 40 of FIG. 2 need be included in such a presentation in accordance with the present invention. It should also be understood that weather condition information other than that shown in the exemplary combined graphical information and time-lapse photography presentation 40 of FIG. 2, e.g., wind speed, etc., may be included in such a presentation in accordance with the present invention. Also, weather information may be presented in similar or entirely different formats from the dynamic graphical information presentation illustrated by example in FIG. 2.

A time-lapse clock display 58 is preferably overlaid on the time-lapse photography video image sequence background 42 of a combined graphical information and time-lapse photography presentation 40 in accordance with the present invention. The time-lapse clock display 58 may be generated and displayed in a conventional manner along with or as part of the dynamic graphical information weather presentation. The dynamic graphical time-lapse clock display 58 presents a viewer of a combined graphical information and time-lapse photography presentation 40 incorporating such a display with an indication of the time of day which is being represented at any one point in time by the combined graphical information and time-lapse photography presentation 40. Thus, the dynamic graphical time-lapse clock display 58 provides real time temporal context to a viewer of the combined graphical information and time-lapse photography presentation 40. Although illustrated, for example, in FIG. 2 as a dynamic graphically represented analog clock 58, it should be understood that a time-lapse clock display to be included in a combined graphical information and time-lapse photography presentation in accordance with the present invention may be presented in any appropriate format for indicating real time in the combined presentation 40.

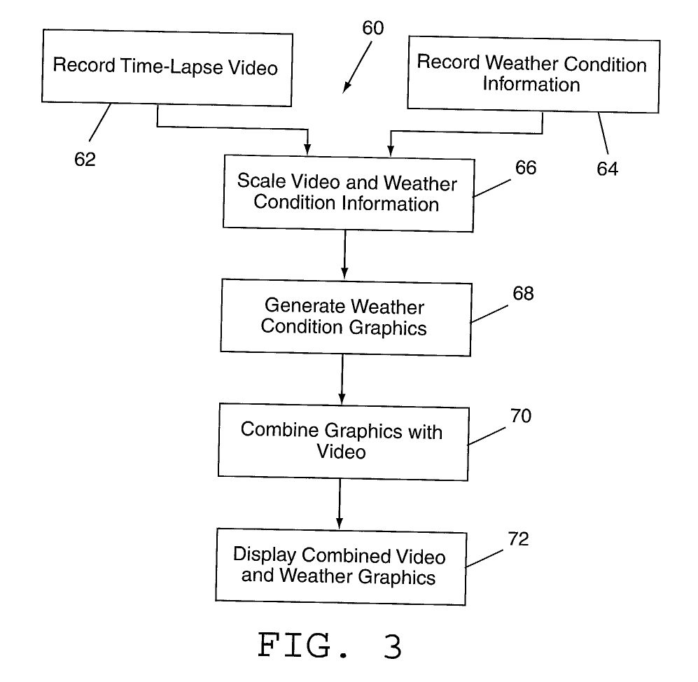

An exemplary method 60 for generating a combined graphical information and time-lapse photography presentation of past weather conditions is illustrated in, and will be described with reference to, the flowchart diagram of FIG. 3. It should be understood that the steps of the method 60 illustrated in the flowchart diagram of FIG. 3 may be performed in a different order from that presented in FIG. 3 and discussed below. A programmer skilled in the art will be able to implement many of the functions performed by the method to be discussed below in a conventional computer processor system. Such computer implemented functionality may include graphical or other user interfaces, e.g., presented on the processor output device 14, which allow an operator of the system 10 to interact with the software program, e.g., via input device 13, to make necessary user selections and otherwise control operation of the process of generating a combined graphical information and time-lapse photography presentation in accordance with the present invention.

The first two steps of a method 60 for generating a combined graphical information and time-lapse photography weather presentation of past weather conditions in accordance with the present invention are to obtain a time-lapse photography video image sequence for a period of interest 62 and to record weather condition information for the same period 64. As discussed above, the step 62 of recording a time-lapse photography video image sequence for a time period of interest may be performed by a system processor 12, which controls a video camera 24 to take, for example, a time-lapse photography video image sequence of sky conditions over a selected time period. The processor 12 may control operation of the camera 24 to record image frames at spaced apart time intervals, such that when the image sequence thus obtained is played back at a normal speed, a sped-up time-lapse photography video image sequence is provided. To prevent an abrupt start and stop to the time-lapse photography video image sequence when replayed, the processor 12 may control the camera 24 to obtain a time-lapse photography video image sequence which, when played back, accelerates gradually from normal speed at the beginning of the presentation and decelerates gradually to normal speed at the end of the presentation. This may be achieved by controlling the camera 24 to record video frames more frequently near the beginning and ends of the time-lapse photography video image sequence, while gradually increasing the time between the recording of video clips as the time from the two ends of the video image sequence increases, such that a sped-up time-lapse video presentation is provided during the middle of the sequence, with video images recorded at a more normal speed at the beginning and end thereof. The video image frames forming the time-lapse photography video image sequence obtained may be time stamped, e.g., employing the processor real time clock function 26, as each frame or a selected subset of frames are taken. The time-lapse photography video image sequence recorded in step 62 may be saved in conventional digital or analog video storage medium 25, as discussed above.

Weather condition information is recorded from one or more weather information sources 18, 19, and/or 20, at step 64 over the same time period for which a time-lapse photography video image sequence is obtained at step 62. For example, each time a video image frame, or a selected subset of frames, is taken by the video camera 24 under control of the system processor 12, the system processor 12 may also record a set of weather condition information from one or more of the weather information sources 18, 19, and/or 20. Such weather condition information, e.g., current temperature, wind speed, wind direction, cumulative precipitation, etc., may be stored by the processor 12 in the weather condition information database portion 16 of memory 15 associated with the processor 12. Each time weather information is obtained and recorded by the system 10 from weather information sources 18, 19 and/or 20, the real time clock function 26 implemented in the system processor 12 is queried and the weather information obtained is time stamped accordingly. Alternatively, the system processor 12 may obtain and record time stamped weather condition information for the period over which the time-lapse photography video image sequence is obtained at time intervals which do not necessarily correspond with the time periods at which video image sequence frames forming the time-lapse photography video image sequence are obtained.

Preferably, in a combined graphical information and time-lapse photography presentation in accordance with the present invention, the time-lapse photography video image sequence and dynamic graphical information presentation forming the combined presentation are timeframe synchronized. In other words, for any given point in time during the combined graphical information and time-lapse photography presentation the graphical weather information presented at that time in the combined presentation should correspond to the weather condition information obtained at the same, or substantially the same, point in real time as the corresponding video image frame was taken. Such timeframe synchronization may be obtained by scaling at 66 the time-lapse photography video image sequence obtained at 62 and the weather condition information obtained at 64 to cover the same timeframe, including any acceleration or deceleration in the time-lapse photography video image sequence to smooth the time-lapse photography video image sequence presentation as described above. Such scaling is performed automatically if weather condition information is obtained at 64 each time a corresponding frame of the time-lapse photography video image sequence is obtained. If such simultaneous time synchronized obtaining of the video image sequence and weather condition information is not performed, scaling of the time-lapse photography video image sequence and recorded weather condition information may be performed using time stamps associated with the recorded time-lapse photography video image sequence and weather condition information obtained over the same time period. For example, for each time stamped frame, or selected subset of frames, in the time-lapse photography video image sequence, the system processor 12 may retrieve for use from the weather database 16 the recorded weather condition information for that time, or for a nearly associated time. This, however, is only possible if the time-lapse photography video image sequence and weather condition information obtained over a selected time period are time stamped using the same real time clock function 26, or using separate but time synchronized real time clocks.

A dynamic graphical weather information presentation is generated at 68 from the selected and scaled weather condition information. As described above, the dynamic graphical weather information presentation is a dynamic animated graphical presentation of changing weather conditions over a selected period of time. Such a dynamic graphical information presentation may be generated in a conventional manner, using conventional computer graphics generation techniques. The dynamic graphical weather information presentation generated at 68 should be generated in such a way as to maintain time synchronization between the generated dynamic graphical weather information presentation and the recorded time-lapse photography video image sequence with which the dynamic graphical weather information presentation is to be combined.

The dynamic graphical weather information presentation is combined with the time-lapse photography video image sequence to form a combined graphical information and time-lapse photography presentation in accordance with the present invention at 70. As discussed above, the dynamic graphical weather information presentation may be combined with the time-lapse photography video image sequence by overlaying the dynamic graphical weather information presentation over a background of the time-lapse photography video image sequence. This may be accomplished in a conventional manner, e.g., by, for each frame in the combined graphical information and time-lapse photography presentation, using conventional compositing techniques for replacing selected picture elements of the time-lapse photography video image sequence with the dynamic graphical weather information presentation.

The resulting combined graphical information and time-lapse photography presentation generated at 70 may be displayed, e.g., as part of a televised weather report presentation, at 72. Before presenting the combined graphical information and time-lapse photography presentation as part of a broadcast report, the combined graphical information and time-lapse photography presentation may preferably be previewed by an operator of the system 10, e.g., on a system output device 14, such as a system monitor. Additionally, or alternatively, the combined graphical information and time-lapse photography presentation generated in accordance with the present invention may be saved, in a conventional manner, in digital or analog form, for future playback, and/or transmitted to viewers over any known conventional media channel.

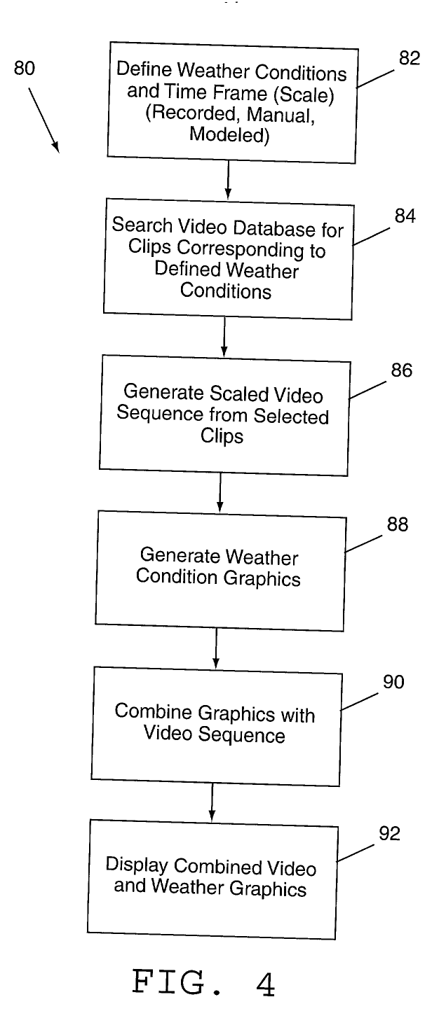

An exemplary method 80 for generating a combined graphical information and time-lapse photography presentation of forecast weather conditions in accordance with the present invention is illustrated in the flowchart diagram of FIG. 4, and will be described in detail with reference thereto. As discussed above, with reference to the flowchart diagram of FIG. 3, the steps presented in the flowchart diagram of FIG. 4 may be performed in a different order from that presented therein, and many of the steps may be implemented for automatic operation in a computer system.

Weather condition information displayed in a combined graphical information and time-lapse photography weather presentation of forecast weather conditions in accordance with the present invention is based on forecast weather conditions for a selected time period of interest defined by an operator at 82. The operator must select the timeframe of interest for the presentation as well as the forecast weather conditions to be represented in the presentation. Forecast weather conditions may be obtained from a variety of sources, including forecast weather conditions which were obtained from external to the system 10, and recorded in the weather database 16, forecast weather conditions entered manually into the system 10 by a meteorologist, e.g., using the system input device 13, and/or forecast weather conditions which are generated internal to the system, e.g., using a weather condition forecasting model 22. An operator may also wish to select a particular presentation format for the combined graphical information and time-lapse photography presentation to be generated, such as, for example, smooth acceleration and deceleration of the presentation at the beginning and end thereof, as discussed above.

Having defined the forecast weather conditions to be included in the combined graphical information and time-lapse photography presentation, appropriate video image sequences corresponding to the forecast weather condition information must be obtained. Preferably, a plurality of pre-recorded video image sequences for various different weather conditions and times of day may be stored in the system 10, e.g., in video storage 25, and organized for easy retrieval via a video image sequence database 17 stored in memory 15. Such stored video image sequences may be labeled with appropriate descriptors before being saved, so as to allow for easy retrieval. Such descriptors should correspond to the type of forecast weather conditions which are to be included in a combined graphical information and time-lapse photography weather forecast presentation. For example, typical video image sequence descriptors may be: (clear, morning to noon); (cloudy, morning to noon, wind from south); (cloudy, morning to noon, wind from north); (raining, morning to noon); etc. Based on these descriptors, an operator of the system 10 may easily retrieve pre-recorded video image sequences corresponding to the forecast weather conditions to be included in the combined graphical information and time-lapse photography weather forecast presentation. Alternatively, the system 10 may be programmed to retrieve automatically via the video database 17 appropriate video image sequences corresponding to the forecast weather conditions to be included in the combined graphical information and time-lapse photography weather forecast presentation.

At step 86 the selected video image sequences are combined and scaled to form an integrated video image sequence for the timeframe and scale previously indicated by the operator at step 82. This may require combining several stored video image sequence clips in an appropriate order corresponding to changing weather conditions represented in the forecast weather condition information to be included in the combined graphical information and time-lapse photography presentation.

At step 88, a computer generated dynamic graphical weather information presentation is generated from the forecast weather conditions for the time period to be represented in the combined graphical information and time-lapse photography presentation, in the manner described above. The resulting dynamic graphical information presentation and the time scaled video image sequence are combined, in the manner described above, at 90, and presented, e.g., as part of a televised broadcast, in the manner described above, at 92.

The present invention is not limited to the particular exemplary applications and embodiments illustrated and described herein, but embraces such modified forms thereof as come within the scope of the following claims.

What is claimed is:

1. A method for generating a combined graphical information and time-lapse photography presentation, comprising:
(a) providing a time-lapse photography video image sequence;
(b) generating a dynamic graphical information presentation; and
(c) combining the dynamic graphical information presentation with the time-lapse photography video image sequence to form a combined graphical information and time-lapse photography presentation in which both the time lapse video image sequence and the dynamic graphical information presentation change dynamically when the combined graphical information and time lapse photography presentation is played.

2. The method of claim 1 comprising additionally the step of time synchronizing the time-lapse photography video image sequence and the dynamic graphical information presentation.

3. The method of claim 2 wherein the step of time synchronizing the time-lapse photography video image sequence and the dynamic graphical information presentation includes the step of time synchronizing the time-lapse photography video image sequence and the dynamic graphical information presentation such that the perceived speed of both the time-lapse photography video image sequence and of the dynamic graphical information presentation accelerates at a beginning of the combined graphical information and time-lapse photography presentation and decelerates at an end of the combined graphical information and time-lapse photography presentation at the same rate.

4. The method of claim 1 comprising additionally the step of combining a time-lapse clock display with the combined graphical information and time-lapse photography presentation.

5. The method of claim 4 wherein the step of generating the dynamic graphical information presentation includes the step of generating the time-lapse clock display.

6. The method of claim 1 wherein the step of providing a time-lapse video image sequence includes the step of obtaining a time-lapse video image of sky conditions over a selected time period, comprising additionally the step of recording weather information over the selected time period, and wherein the step of generating the dynamic graphical information presentation includes the step of generating a dynamic graphical weather information presentation from the recorded weather information.

7. The method of claim 6 wherein the step of obtaining a time-lapse video image of sky conditions and the step of recording weather information are performed in a time synchronized manner.

8. The method of claim 6 wherein the step of recording weather information over the selected time period includes the step of recording weather information selected from the group of types of weather information consisting of: type of precipitation, quantity of precipitation, temperature, wind speed, and wind direction.

9. The method of claim 1 wherein the step of providing a time-lapse photography video image sequence includes the step of selecting a video image sequence from a plurality of stored video image sequences.

10. The method of claim 9 comprising additionally the step of obtaining weather condition forecast information, wherein the step of generating a dynamic graphical information presentation includes the step of generating a dynamic graphical weather information presentation from the weather condition forecast information, and wherein the step of providing a time-lapse photography video image sequence includes the step of selecting a video image sequence of sky conditions corresponding to the weather condition forecast information from a plurality of stored video image sequences of a variety of sky conditions.

11. A system for generating a combined graphical information and time-lapse photography presentation, comprising:
(a) means for obtaining a time-lapse photography video image sequence;
(b) means for generating a dynamic graphical information presentation; and
(c) means for combining the dynamic graphical information presentation with the time-lapse photography video image sequence to form a combined graphical information and time-lapse photography presentation in which both the time lapse video image sequence and the dynamic graphical information presentation change dynamically when the combined graphical information and time lapse photography presentation is played.

12. The system for generating a combined graphical information and time-lapse photography presentation of claim 11 comprising additionally means for time synchronizing the time-lapse photography video image sequence and the dynamic graphical information presentation.

13. The system for generating a combined graphical information and time-lapse photography presentation of claim 11 comprising additionally means for combining a time-lapse clock display with the combined graphical information and time-lapse photography presentation.

14. The system for generating a combined graphical information and time-lapse photography presentation of claim 11 wherein the means for obtaining a time-lapse video image sequence includes a computer processor controlled video camera.

15. The system for generating a combined graphical information and time-lapse photography presentation of claim 11 comprising additionally means for recording weather information over a selected time period, and wherein the means for generating the dynamic graphical information presentation includes means for generating a dynamic graphical weather information presentation from the recorded weather information.

16. The system for generating a combined graphical information and time-lapse photography presentation of claim 15 wherein the means for recording weather information over the selected time period includes an automated weather station for gathering automatically the weather information.

17. The system for generating a combined graphical information and time-lapse photography presentation of claim 11 wherein the means for obtaining a time-lapse photography video image sequence includes means for selecting a video image sequence from a plurality of stored video image sequences.

18. The system for generating a combined graphical information and time-lapse photography presentation of claim 11 comprising additionally means for obtaining weather condition forecast information, wherein the means for generating a dynamic graphical information presentation includes means for generating a dynamic graphical weather information presentation from the weather condition forecast information, and wherein the means for obtaining a time-lapse photography video image sequence includes means for selecting a video image sequence of sky conditions corresponding to the weather condition forecast information from a plurality of stored video image sequences of a variety of sky conditions.

19. The system for generating a combined graphical information and time-lapse photography presentation of claim 11 wherein the means for generating a dynamic graphical information presentation and the means for combining the dynamic graphical information presentation with the time-lapse photography video image sequence to form a combined graphical information and time-lapse photography presentation include a computer processor system.

20. A method for generating a combined dynamic graphical information and video sequence weather forecast presentation, comprising the steps of:
(a) obtaining weather condition forecast information;
(b) generating a dynamic graphical information presentation from the weather condition forecast information;
(c) obtaining a video image sequence of sky conditions corresponding to the weather condition forecast information; and
(d) combining the dynamic graphical information presentation and the video image sequence to form a combined dynamic graphical information and video sequence weather forecast presentation in which both the video image sequence and the dynamic graphical information presentation change dynamically when the combined graphical information and video presentation is played.

21. The method of claim 20 wherein the step of obtaining the weather condition forecast information includes the step of running a weather forecasting computer model.

22. The method of claim 20 wherein the step of obtaining a video image sequence includes the step of selecting a video image sequence of sky conditions corresponding to the weather condition forecast information from a plurality of stored video image sequences of a variety of sky conditions.

23. The method of claim 22 wherein the step of selecting a video image sequence of sky conditions corresponding to the weather condition forecast information from a plurality of stored video image sequences of a variety of sky conditions is performed automatically.

24. The method of claim 20 wherein the step of obtaining a video image sequence includes the step of obtaining a time-lapse photography video image sequence of sky conditions corresponding to the weather condition forecast information.

25. A system for generating a combined dynamic graphical information and video sequence weather forecast presentation, comprising:
(a) means for obtaining weather condition forecast information;
(b) means for generating a dynamic graphical information presentation from the weather condition forecast information;
(c) means for obtaining a video image sequence of sky conditions corresponding to the weather condition forecast information; and
(d) means for combining the dynamic graphical information presentation and the video image sequence to form a combined dynamic graphical information and video sequence weather forecast presentation in which both the video image sequence and the dynamic graphical information presentation change dynamically when the combined graphical information and video presentation is played.

26. The system for generating a combined dynamic graphical information and video sequence weather forecast presentation of claim 25 wherein the means for obtaining weather condition forecast information includes a weather forecasting computer model.

27. The system for generating a combined dynamic graphical information and video sequence weather forecast presentation of claim 25 wherein the means for obtaining a video image sequence includes means for selecting a video image sequence of sky conditions corresponding to the weather condition forecast information from a plurality of stored video image sequences of a variety of sky conditions.

28. The system for generating a combined dynamic graphical information and video sequence weather forecast presentation of claim 25 wherein the means for obtaining a video image sequence includes the step of obtaining a time-lapse photography video image sequence of sky conditions corresponding to the weather condition forecast information.

29. The system for generating a combined dynamic graphical information and video sequence weather forecast presentation of claim 25 wherein the means for generating a dynamic graphical information presentation from the weather condition forecast information and the means for combining the dynamic graphical information presentation and the video image sequence to form a combined dynamic graphical information and video sequence weather forecast presentation include a computer processor system.
